(19) United States
(12) Patent Application Publication
(10) Pub. No.: US 2007/0063982 A1
(43) Pub. Date: Mar. 22, 2007

(54) Integrated rendering of sound and image on a display

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 11/230,272

(22) Filed: Sep. 19, 2005

(51) Int. Cl. G09G 5/00

(52) U.S. Cl. 345/173

(57) ABSTRACT

Systems and methods are disclosed for providing computer input/output includes rendering an image on a display while generating sound with a sheet of optically clear material positioned above the display, and receiving data input from a touch sensitive array formed on the sheet.

### BACKGROUND

The present invention relates generally to integrated sound and image rendering.

Speakers are used in a variety of applications including audio, radio receivers, stereo equipment, cellular telephones, speakerphone systems, and a variety of other devices such as in conjunction with computer displays. United States Patent Application 20040189151, the content of which is incorporated herewith, discloses a mechanical-to-acoustical transformer and multi-media flat film speaker having one actuator, preferably a piezo motor, that is connected to one edge of a diaphragm formed from a thin, flexible sheet material. The diaphragm is fixed at a point spaced from the actuator in the direction of its motion so that excursion of the actuator is translated into a corresponding, mechanically-amplified, excursion of the diaphragm—typically amplified five to seven times. The diaphragm is parabolically curved and, if optically clear, can be mounted on a frame over a video display screen to provide a screen speaker.

### SUMMARY

In a first aspect, an integrated tactile audio visual apparatus includes a display; a touch sensitive array provided on a sheet of optically clear material positioned above the display; and an electro-mechanical actuator to move the sheet to generate sound.

Implementations of the apparatus may include one or more of the following. The touch sensitive array can be one of: resistive touch sensor, capacitive touch sensor, inductive touch sensor. The touch sensitive array can vibrate in response to a touch to provide tactile feedback. The touch sensitive array can provide keyboard tactile feedback during typing. The actuator can be a MEMS device or a piezoelectric device. The actuator can be driven with an electro-acoustical physical model. The actuator sinusoidally modulates the sheet. The display comprises a 3D display. The 3D display superimposes a first image for a left eye and a second image for a right eye.

In another aspect, a stereo audio visual system includes a display having an array of pixels; first and second sheets of optically clear materials positioned above the display, each sheet having a touch sensitive array thereon; and first and second electro-mechanical actuators coupled to the first and second sheets of optically clear material to generate stereo sound.

Implementations can include one or more of the following. The touch sensitive array can include one of: resistive touch sensor, capacitive touch sensor, inductive touch sensor. The system can vibrate the sheet in response to a touch to provide tactile feedback. Each actuator can be driven with an electro-acoustical physical model. Each actuator can sinusoidally modulate the sheet. The display can render a 3D display. The 3D display provides a first image for a left eye and a second image for a right eye for 3D rendering.

In another aspect, a method for providing computer input/output includes rendering an image on a display while generating sound with a sheet of optically clear material positioned above the display, and receiving data input from a touch sensitive array on the sheet.

Implementations can include one or more of the following. The touch sensitive array can include one of: resistive touch sensor, capacitive touch sensor, inductive touch sensor. The system can vibrate the sheet in response to a touch to provide tactile feedback. The method includes providing keyboard tactile feedback during typing. The method further includes actuating the sheet using an electro-acoustical physical model. The method includes rendering a first image for a left eye and a second image for a right eye.

Advantages may include one or more of the following. The system can project sound and video together to provide a rich audio visual experience. The system minimizes space as it combines the display and the speaker system into one suitable for portable devices such as portable DVD players, cell phones and PDAs. Further, touch sensitive input is provided with vibrational feedback. The system is inexpensive to manufacture and is less expensive and more reliable than conventional alternatives.

### BRIEF DESCRIPTION OF THE DRAWINGS

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary device with integrated sound and image rendering.

FIG. 2 illustrates an exemplary process to provide integrated sound and image rendering.

FIG. 3 shows an exemplary cell phone in accordance with one aspect of the invention.

FIG. 4 shows an exemplary portable computer in accordance with one aspect of the invention.

### DESCRIPTION

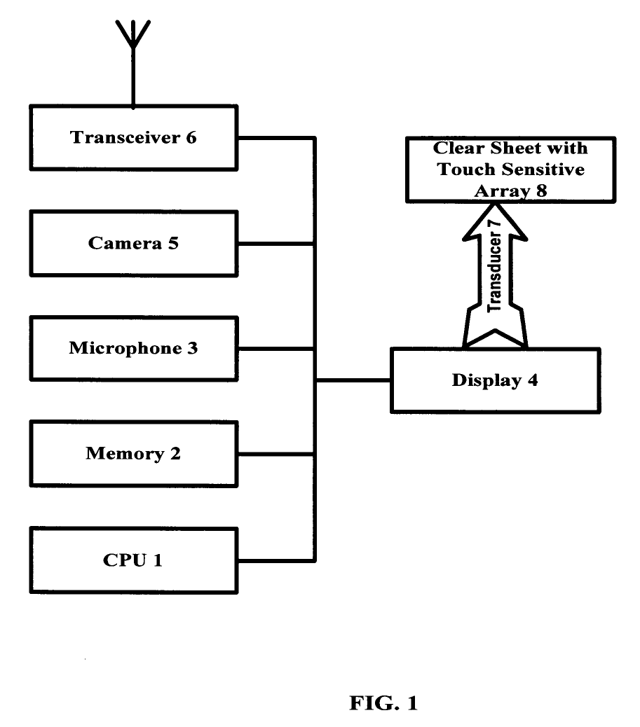

FIG. 1 shows an exemplary portable data-processing device having enhanced I/O peripherals. In one embodiment (such as a cell-phone or a PDA, among others), the device has a processor 1 connected to a memory array 2 that can also serve as a solid state disk. The processor 1 is also connected to a microphone 3, a display 4 and a camera 5. A wireless transceiver 6 may be connected to the processor 1 to communicate with remote devices. For example, the wireless transceiver can be WiFi, WiMax, 802.X, Bluetooth, infra-red, cellular transceiver (CDMA/GPRS/EDGE), all, one or more, or any combination thereof. An optically clear sheet 8 is positioned above the display 4 and is actuated by an actuator 7. The actuator 7 moves the clear sheet 8 to produce sounds that emanate from the display 4 to provide an integrated audio/visual experience for a user. The sheet 8 also includes a touch sensitive array for sensing user inputs directed at the sheet. The touch sensitive array is provided on the sheet 8 to receive contact inputs from a user. In one embodiment, the actuator 7 operates substantially in the frequency range of the human voice and on up (100-20 kHz). The thin, stiffly flexible and optically clear sheet 8 has a slight curvature and can be made of optical quality plastic such as polycarbonate or tri-acetate, or tempered glass sheet. A gasket can be used to seal the edges of the sheet to maintain an acoustic pressure gradient across the sheet if necessary.

The touch sensitive array can include one of: resistive touch sensor, capacitive touch sensor, inductive touch sensor. The system can vibrate the sheet in response to a touch to provide tactile feedback. Each actuator can be driven with an electro-acoustical physical model. Each actuator can sinusoidally modulate the sheet. The display can render a 3D display. The 3D display provides a first image for a left eye and a second image for a right eye for 3D rendering. Techniques for providing 3D rendering is disclosed in co-pending application Ser. No. 11/______ entitled “SYSTEMS AND METHODS FOR 3D RENDERING”, the content of which is incorporated by reference.

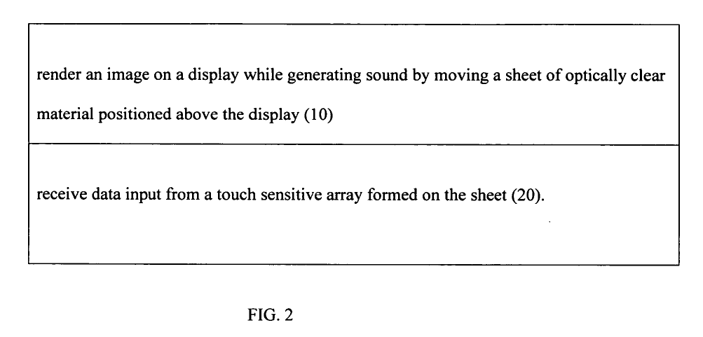

FIG. 2 shows an exemplary method for providing computer input/output that includes rendering an image on a display while generating sound by moving a sheet of optically clear material positioned above the display (10), and receiving data input from a touch sensitive array formed on the sheet (20).

In one embodiment, the processor 1 can command the actuator 7 to move in accordance with a dynamic electro-physical model of the sheet 8 as a speaker and an acoustic model of its enclosure and optionally, other acoustic factors such as sound shaping. The process includes characterizing the electro-mechanical transducer or actuator 7 using the microphone 3; generating an electro-physical model of the electro-mechanical transducer or actuator 7; and digitally modulating the actuator 7 based on the derived model. In order to ensure that the model remains faithful to actual transducer movements, at least one point of sheet 8 travel should be monitored; preferably the center, or rest point. The more points monitored during the actuator's motion, the greater the compliance of the model, hence higher possible fidelity reproduction of the audio signal. The modulation can be based upon the amount of energy required to move the electro-mechanical actuator 7. The actuator 7 and/or the sheet 8 can have mechanical flexure and the generating a physical model can compensate for mechanical flexure. The actuator 7 and/or the sheet 8 can have a non-linearity and the generating of the model can compensate for the non-linearity. The actuator 7 and/or the sheet 8 can have one or more limits of travel and the physical model can compensate for the one or more limits of travel. The drive signal can be modified to avoid moving the actuator 7 and/or the sheet 8 into positions that create undesirable sound. The drive signal can be modified using a predictive model to calculate the position or momentum of the actuator 7 and/or the sheet 8.

In one embodiment, the display 4 can have a surface that is non-rigid and MEMS actuator under the surface moves the surface of the display 4 to conduct sound into the user's cochlear to provide sound to the user in a secure manner. In this embodiment, software can calibrate the MEMS actuator to optimize sound generation to the user's specific anatomical characteristics in the manner discussed above.

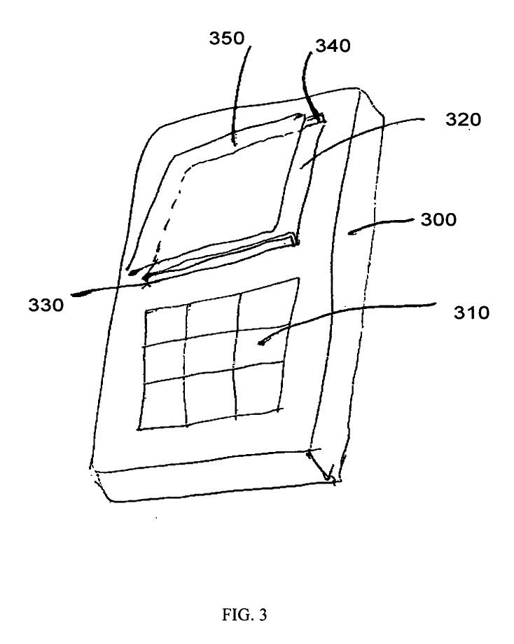

FIG. 3 shows an exemplary cell phone 300 in accordance with one aspect of the invention. In FIG. 3, the cell phone 300 has a keypad 310 and a display 320. Actuators 330 and 340 are positioned on either sides of the display 320, and a clear sheet 350 is positioned above the display 320 as a diaphragm that can be moved by actuators 330 and 340 to produce sound emanating from the display 320. Moreover, the sheet 350 can receive touch input as well.

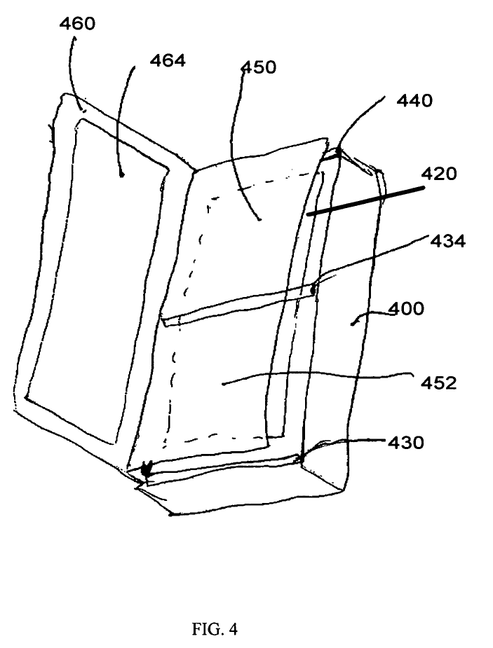

FIG. 4 shows an exemplary portable computer 400 in accordance with another aspect of the invention. The portable computer can be a laptop, a PDA, or a cell phone, among others. The computer 400 has first and second displays 420 and 464. The second display 464 is supported by a panel 460 which can be closed, while the first display 420 is positioned opposite the second display 464 when the panel 460 is folded into a closed position. Actuators 430, 434 and 440 are positioned above the display 420 and are adapted to move clear sheets 450 and 452, respectively. In this embodiment, the display 464 can be a conventional display, while the sheet 450-452 and display 420 combination provides tactile audio/visual feedback to the user. The display 420 can render a keyboard or any other suitable UI buttons, and when the user presses on the touch-screen UI, the computer can respond suitable to the selected UI. Additionally, the sheet 450-452 can be actuated to vibrate and provide tactile feedback as the user enters information into the touch-screen. At the same time, clicking sounds can emanate from the screen 420 to provide audio feedback. Alternatively, audio data can emanate from the display 420/sheet 450-452 toward the user.

The sheets can contain a solar cell embedded therein. The solar cell can be a power-generating active-matrix display with a first region having a plurality of solar cells arranged in a matrix; and a second region having a plurality of thin film transistors, each of which is associated with a pixel electrode and wherein the solar cells overlie respective pixel electrodes. Alternatively, the solar cell can be formed on plastic rolls which are then integrated with the sheets. Alternatively, the solar cell can have nanorods dispersed in an organic polymer or plastic. A layer only 200 nanometers thick is sandwiched between electrodes to generate electricity. The electrode layers and nanorod/polymer layers could be applied in separate coats, making production easy. The plastic solar cells can be manufactured in solution in a beaker without the need for clean rooms or vacuum chambers.

Portions of the system and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The system has been described in terms of specific examples which are illustrative only and are not to be construed as limiting. In addition to software, the system may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

The present invention has been described in terms of specific embodiments, which are illustrative of the invention and not to be construed as limiting. Other embodiments are within the scope of the following claims. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention.

What is claimed is:

1. An integrated tactile audio visual apparatus, comprising:
a display;
a touch sensitive array provided on a sheet of optically clear material positioned above the display; and
an electro-mechanical actuator to move the sheet to generate sound.

2. The apparatus of claim 1, wherein the touch sensitive array comprises one of: resistive touch sensor, capacitive touch sensor, inductive touch sensor.

3. The apparatus of claim 1, wherein the touch sensitive array vibrates in response to a touch to provide tactile feedback.

4. The apparatus of claim 1, wherein the touch sensitive array provides keyboard tactile feedback during typing.

5. The apparatus of claim 1, wherein the actuator comprises one of: a MEMS device, a piezoelectric device.

6. The apparatus of claim 1, wherein the actuator is driven with an electro-acoustical physical model.

7. The apparatus of claim 1, wherein the actuator sinusoidally modulates the sheet.

8. The apparatus of claim 1, wherein the display comprises a 3D display and wherein the display superimposes a first image for a left eye and a second image for a right eye.

9. The apparatus of claim 1, wherein the sheet comprises a solar cell.

10. A stereo audio visual system, comprising:
a display having an array of pixels;
first and second sheets of optically clear materials positioned above the display, each sheet having a touch sensitive array thereon; and
first and second electro-mechanical actuators coupled to the first and second sheets of optically clear material to generate stereo sound.

11. The apparatus of claim 10, wherein each actuator is driven with an electro-acoustical physical model.

12. The apparatus of claim 10, wherein each actuator sinusoidally modulates the sheet.

13. The apparatus of claim 10, wherein the display comprises a 3D display and wherein the display provides a first image for a left eye and a second image for a right eye for 3D rendering.

14. The apparatus of claim 10, wherein one of the sheet comprises a transparent solar cell.

15. A method for providing computer input/output, comprising:
rendering an image on a display while generating sound by moving a sheet of optically clear material positioned above the display, and
receiving data input from a touch sensitive array formed on the sheet.

16. The method of claim 15, wherein the touch sensitive array comprises one of: resistive touch sensor, capacitive touch sensor, inductive touch sensor.

17. The method of claim 15, comprising vibrating the sheet in response to a touch to provide tactile feedback.

18. The method of claim 15, comprising providing keyboard tactile feedback during typing.

19. The method of claim 15, comprising actuating the sheet using an electro-acoustical physical model.

20. The method of claim 15, comprising rendering a first image for a left eye and a second image for a right eye.
